(19) United States
(12) Patent Application Publication
(10) Pub. No.: US 2018/0164760 A1
(43) Pub. Date: Jun. 14, 2018

(54) SYSTEM AND METHOD TO CONSTRUCT DIAGNOSTIC DEPENDENCE MODEL

(71) Applicant: HONEYWELL INTERNATIONAL INC., Morris Plains, NJ (US)

(72) Inventors: Tim Felke, Damascus, MD (US); Martin Ludvik, Prerov,Olomoucky Kraj (CZ); Tim Mahoney, Chandler, AZ (US); Jeff vanderZweep, Peoria, AZ (US)

(73) Assignee: HONEYWELL INTERNATIONAL INC., Morris Plains, NJ (US)

(21) Appl. No.: 15/053,321

(22) PCT Filed: Feb. 22, 2016
(86) PCT No.: PCT/US2016/018894

§ 371 Date: Feb. 25, 2016

Related U.S. Application Data
(60) Provisional application No. 62/119,438, filed on Feb. 23, 2015.

(51) Int. Cl. G05B 17/02; G05B 23/02; G06F 17/30; G06F 11/07

(52) U.S. Cl. CPC G05B 17/02; G05B 23/02; G06F 11/079; G06F 17/30115; G06F 17/30076

(57) ABSTRACT

Systems and methods for building a dependency diagnostic model of a complex system are provided. The system may include, but is not limited to, a processor, the processor configured to receive at least one function model corresponding to each assembly of the complex system, at least one health and condition indicator model corresponding to an output of the complex system, a program data dictionary, standard failure modes and propagation rules, determine interdependencies between the plurality of assemblies of the complex system and the output of the complex system based upon the at least one function model, the at least one health and condition indicator model and the program data dictionary, generate the diagnostic model based upon the determined interdependencies between assemblies of the complex system and the output of the complex system, and optimize the generated diagnostic model based upon the standard failure modes and the propagation rules.

### CROSS-REFERENCE TO RELATED APPLICATION(S)

This application claims the benefit of PCT application PCT/US16/18894, filed Feb. 22, 2016, which claims the benefit of U.S. provisional patent application Ser. No. 62/119,438, filed Feb. 23, 2015, the entire contents of which are incorporated by reference herein.

### TECHNICAL FIELD

The present disclosure generally relates to diagnostic systems, and more particularly relates to building models for diagnostic systems.

### BACKGROUND

Complex systems, such as aircraft, automobiles, spacecraft or other complex machinery include numerous integrated systems. Diagnosing particular faults in the complex systems can be difficult due to the large number of components in each complex system as well as the complex interactions between the large number of components. In other words, a first system may be dependent upon multiple other systems in the complex system. Thus, a fault at the first system can be difficult to trace to root problems.

Health management applications are a useful tool for diagnosing faults in complex systems. When given an accurate model, health management applications can trace diagnostic trouble codes to specific root problems. However, health management applications require accurate models in order to perform their function.

### BRIEF SUMMARY

In one embodiment, for example, a system for building a dependency diagnostic model of a complex system having a plurality of assemblies is provided. The system may include, but is not limited to, a processor, the processor configured to receive at least one function model corresponding to each assembly of the complex system, at least one health and condition indicator model corresponding to an output of the complex system, a program data dictionary, standard failure modes and propagation rules, determine interdependencies between the plurality of assemblies of the complex system and the output of the complex system based upon the at least one function model, the at least one health and condition indicator model and the program data dictionary, generate the diagnostic model based upon the determined interdependencies between assemblies of the complex system and the output of the complex system, and optimize the generated diagnostic model based upon the standard failure modes and the propagation rules.

In another embodiment, for example, a method for generating a dependency diagnostic model for a complex system having a plurality of assemblies is provided. The method may include, but is not limited to, receiving, by a processor, at least one function model corresponding to each assembly of the complex system, at least one health and condition indicator model corresponding to an output of the complex system, a program data dictionary, standard failure modes and propagation rules, determining, by the processor, interdependencies between the plurality of assemblies of the complex system and the output of the complex system based upon the at least one function model, the at least one health and condition indicator model and the program data dictionary, generating, by the processor, the dependency diagnostic model based upon the determined interdependencies between assemblies of the complex system and the output of the complex system, and optimizing, by the processor, the generated dependency diagnostic model based upon the standard failure modes and the propagation rules.

### BRIEF DESCRIPTION OF THE DRAWINGS

The detailed description will hereinafter be described in conjunction with the following drawing figures, wherein like numerals denote like elements, and wherein:

FIG. 1 illustrates a block diagram of a dependency diagnostic model building system, in accordance with an embodiment;

FIG. 2 is a block diagram illustrating an exemplary dependency diagnostic model building system and a complex system, in accordance with an embodiment;

FIG. 3 is a flow chart illustrating a method for building a model with the model building system, in accordance with an embodiment; and

FIG. 4 is a flow diagram illustrating how the failure modes for a single subsystem of the complex system, customer complaints and health indicators are categorized and connected.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

As discussed in further detail below, a system for automatically building a dependency diagnostic model for a health management system is provided. Building a dependency diagnostic model is a critical step in the development of health management applications for complex systems such as aircraft, automobiles, other vehicles and facilities (manufacturing facilities, test facilities, factories, or the like), or the like.

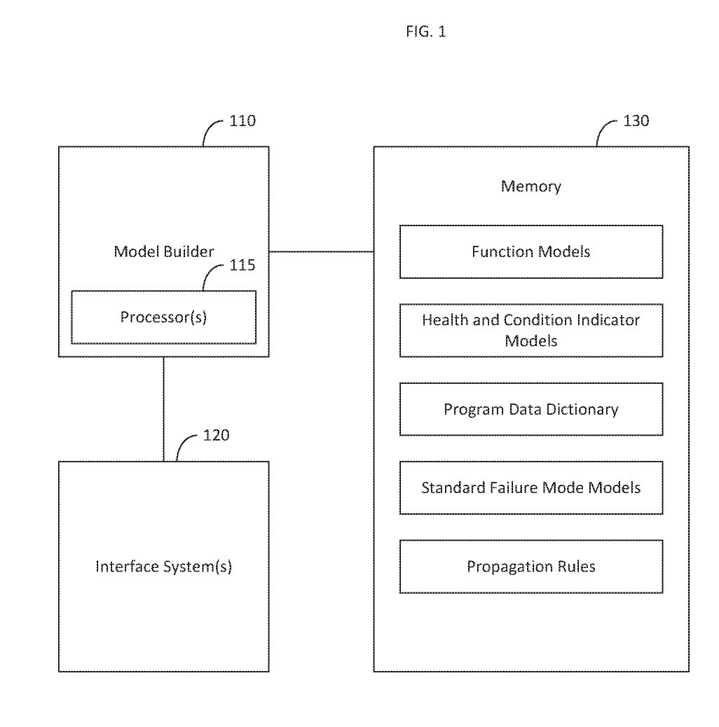

FIG. 1 illustrates a block diagram of a dependency diagnostic model building system 100 in accordance with an embodiment. The dependency diagnostic model building system 100 includes a model builder 110. The model builder 100, for example, may include any combination of hardware and, in some instances software, configured to build a dependency diagnostic model, as discussed in further detail below. The model builder 110 includes at least one processor 115. The processor 115 can be one or more central processing units (CPUs), graphical processing units (GPUs), application specific integrated circuits (ASICs), field programmable gate arrays (FPGAs), microcontrollers, or any other logic devices or any combination thereof. As discussed in further detail below, the processor 115 executes non-transitory computer-readable instructions to build models for a health management system.

The model builder 110 is communicatively coupled to at least one interface system 120. The interface systems 120 can include, but are not limited to, data communication interfaces, displays, diagnostic tools, diagnostic interfaces, user interfaces, computer-readable media readers (e.g., a CD reader, a DVD reader, a Blu-ray disk reader, a compact flash reader, a secure digital (SD) reader, or any other physical media reader) or any combination thereof.

The model building system 100 further includes at least one memory 130. The memory 130 may be located within the model builder 110, may be one or more remote memory units communicatively coupled to the processor 115 via one of the interface systems 120, or a combination thereof. The memory 130 stores computer-readable instructions for implementing the dependency diagnostic model building system 100, as discussed in further detail below.

The memory 130 stores one or more function models 140. Each component of a complex system may have its own function model. Complex systems 200 may have, tens, hundreds, thousands or more functional models. The function models 140 dictate the control of a component of a complex system 200 based upon one or more states or signals of the system. The signals and states may be data based (e.g., vehicle speed, temperature, GPS data, engine RPM), physically based (e.g., gear of the vehicle) or the like, or a combination thereof. For example, if the complex system 200 is an automobile, a control command to increase the engine speed of the vehicle may depending upon one or more states or signals including, but not limited to, the current engine speed, the current engine gear, a gradient of the surface the vehicle is traveling upon, and the like. The function model 140 illustrates how an element of the complex system (hereinafter referred to as an assembly of the complex system) performs a function, such as a command dictating the amount of fuel to inject into the engine, as well as the input (i.e., states and signals) necessary to execute the command. The function models 140, for example, may be Matlab Function models, Simulink models, Unified Modeling Language (UML) models, automotive open system architecture (AUTOSAR) models, or the like. As discussed in further detail below, the model builder 110 leverages the function models 140 to determine how various components of the complex systems are interdependent.

The memory 130 also stores health and condition indicator models 150 corresponding to output of a complex system. In an automotive setting, for example, health indicators may be diagnostic trouble codes (DTC) and condition indicators may be parameter identifiers (PIDs). In complex systems, trouble codes output by the complex system may correspond to the health indicators. Vehicles, for example, often include a readable interface where any triggered health indicator (i.e., a DTC) can be read by a technician. The health indicators indicate that there is a fault in one or more systems of the vehicle. In contrast, condition indicators, such as PIDs in an automotive setting, are codes used to request data from a complex system. When a health management system is coupled to the complex system via, for example, an interface system 120 such as a diagnostic interface, the health management system can request specific data from the vehicle defined by the condition indicators to aid in diagnosis. The health and condition indicator models stored in the memory 130 model each of the health and condition indicators. In other words, the health and condition indicator models define how each health indicator is triggered and how each condition indicator is determined. As discussed in further detail below, by knowing how each health indicator is triggered and how each condition indicator is determined, the health management system can better diagnose the complex system.

The memory 130 further includes a program data dictionary 160. The program data dictionary may include a list of variables corresponding to the same data point. As discussed above, each component of the complex system may have its own function model and its own fault model, which may have not been created by the same person. Accordingly, data points which are utilized by more than one component may have been called by different names in the each function and fault model. The processor 115 thus can utilize program data dictionary to correlate the differently named variables to one another.

The memory 130 further includes standard failure mode models 170. Different components of the complex system have different types of failures. A sensor, for example, may be expected to have an output within a certain range. One standard failure mode for the sensor may be an output outside of the range. Another standard failure mode may be the sensor not outputting data whatsoever. Likewise, components of the complex system dependent upon data from another component may have different responses to the different failure modes of an upstream component. In other words, an assembly of the complex system may have a different response to receiving sensor data which is out of a certain range than to not receiving data from the sensor whatsoever. The processor 115 can thus utilize these standard failure modes and the responses thereto, to narrow down which component of the complex system is at fault.

The memory 130 further includes propagation rules 180. The propagation rules codify how errors propagate through the complex system. For example, multiple diagnostic trouble codes could be output from the complex system. However, multiple codes may not necessarily equate to multiple component failures. Using the example mentioned above, a component having a failure due to not receiving a signal or receiving a signal out of a certain range from a sensor may trigger a first diagnostic trouble code. A power failure (e.g., a voltage out of range or a blown fuse), for example, of a system powering the sensor may cause the complex system to output a second diagnostic trouble code. Thus, although the first diagnostic code may indicate a problem with the sensor, the second diagnostic code indicates a problem upstream from the sensor. Accordingly, the processor can utilize the propagation rules to order a list of possible failure causes such that, for example, a technician analyzes the power system before the technician analyzes the sensor.

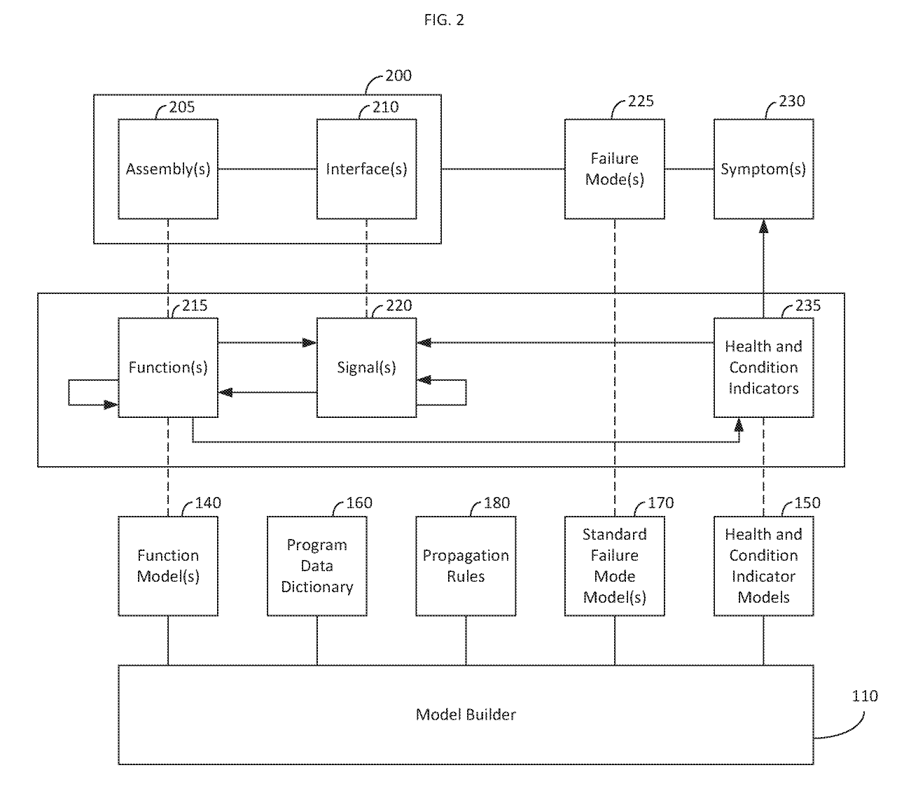

FIG. 2 is a block diagram illustrating an exemplary dependency diagnostic model building system 100 and a complex system 200, in accordance with an embodiment. The complex system 200 includes numerous assemblies 205 interconnected to each other via one or more interfaces 210. Each assembly 205 is a part of the complex system which performs one or more functions based upon one or more states, signals or other functions, as discussed in further detail below. The assemblies 205 and interfaces 210 may vary depending upon the complex system. However, as an example, if the complex system were a vehicle, the assemblies may include an engine, an alternator, a starter motor, a sensor, and airbag system, a fuel pump, an anti-lock braking system, a master cylinder, a spark plug, a controller, a radiator, a water pump, an oil pump, a controller, and numerous other components and subcomponents. The interfaces 210 may be physical interfaces, mechanical interfaces, fluid interfaces, electrical interfaces or a combination thereof.

As illustrated in FIG. 2, each assembly performs one or more functions 215. The function(s) 215 will vary depending upon the assembly 205. However, as an example, if the assembly were a fuel pump, the function would be to pump fuel. As illustrated in FIG. 2, the function 215 of the assembly 205 may depend upon the function of another assembly. As a basic example, an internal combustion engine is dependent upon a fuel pump to deliver fuel. The function(s) 215 of an assembly 205 may also be dependent upon one or more signals 220 received by the assembly through one or more of the interfaces 210. For example, if the assembly 205 were an airbag system, the assembly would be dependent upon receiving a signal 220 indicating a collision or rapid deceleration from one or sensors. As illustrated in FIG. 2, an assembly 205 can also produce one or more signals 220 and output the signal(s) 220 over one or more of the interfaces 210. For example, if the complex system 200 is an aircraft and the assembly 205 is an altimeter, the altimeter on an aircraft may determine an altitude of the aircraft (i.e., the function of the component) and transmit the altitude (i.e., the signal) to a gauge for display, to a flight management system (FMS) and to a navigation system.

Each assembly 205 and interface 210 may have one or more failure modes 225 causing one or more symptoms 230 which may be detectable either by a user of the complex system 200, by an assembly 205 of the complex system 200 or a combination thereof. The failure mode 225 of an assembly 205 generally follow the standard failure modes 170 for the type of assembly 205. For example, any sensor has at least one input (e.g., a power source, control signal, etc.) and at least one output (i.e., the output of the sensor). The standard failure modes for the sensor may include, for example, an input not being received, an input failing high, an input failing low, an output failing high, and output failing low, or no output. In other words, the failure mode 225 of an assembly 205 can vary depending upon whether an upstream assembly 205 has failed (i.e., a signal was not sent by another assembly 205 or a signal sent by another assembly 205 is out of range) or whether the particular assembly 205 itself has failed.

As illustrated in FIG. 2, the function of one or more of the assemblies 205 may be to generate one or more health and condition indicators 235. As discussed above, the health indicators may be diagnostic trouble codes output by the vehicle indicating a problem with one or more parts of the vehicle and parameter identifiers corresponding to a signal 220 output by an assembly. The health and condition indicators 235 correspond to faults in the complex system 200 corresponding to symptoms 230 of faults users of the complex system may identify during operation and symptoms 230 of faults that may only be identifiable during service of the complex system 200.

As illustrated in FIG. 2, function model(s) 140, corresponding to the functions 215 and signals 220, health and condition indicator model(s) 150, corresponding to the health and condition indicators 235, standard failure mode models 170 corresponding to failure mode(s) 225, a program data dictionary 160 and propagation rules 180 are fed into the model builder operated by the processor 115 to build a model for the complex system 200.

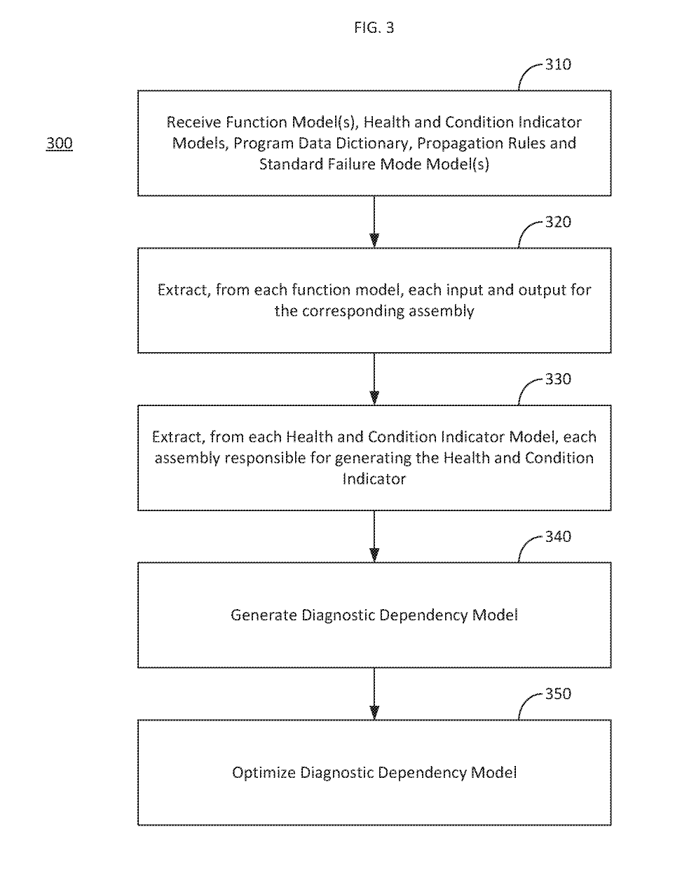

FIG. 3 is a flow chart illustrating a method 300 for building a model with the model building system 100, in accordance with an embodiment. As discussed above, the model building system 100 first receives function model(s) 140, corresponding to the functions 215 and signals 220, health and condition indicator model(s) 150, corresponding to the health and condition indicators 235, standard failure mode models 170 corresponding to the failure mode(s) 225 of the assemblies 205, a program data dictionary 160 and propagation rules 180. (Step 310). The respective input may be received in numerous ways, including, but not limited to, via one or more of the interface systems 120, such as a physical media reader, a communication system, or the like.

The processor 115 of the model building system 100 then processes each function model 140 and extracts from each function model 140 each input and each output to the assembly 205 associated with the function model 140 as well as the function(s) corresponding to the function model 140. (Step 320). As discussed above, the function models 140 may be models created in Matlab, Simulink, Unified Modeling Language (UML), automotive open system architecture (AUTOSAR), or the like. In Matlab, for example, the function model 140 may be a drawing which illustrates the function of the respective assembly 205 as well as the input and output of the respective assembly. In this example, the processor 115 may convert the Matlab based drawing into an XML file and parse the XML file in order to extract the function(s), input(s) and output(s) of each respective function model 140.

The processor 115 of the model building system 100 then processes each health and condition indicator model(s) 150 and extracts from each health and condition indicator model 150 each input and each output to the assembly 205 associated with the respective health or condition indicator 235. (Step 330). The health and condition indicator model(s) 150 may be models created in Matlab, Simulink, Unified Modeling Language (UML), automotive open system architecture (AUTOSAR), or the like. In Matlab, for example, the model may be a drawing which illustrates the function of the respective assembly 205 as well as the input and output of the respective assembly 205. In this example, the processor 115 may convert the Matlab based drawing into an XML file and parse the XML file in order to extract the function(s), input(s) and output(s) of each respective function model.

The processor 115 then builds a dependency diagnostic model based upon the data extracted from the function models 140, the health and condition indicator models 150, and the program data dictionary 160. (Step 340). The processor 115 builds the dependency diagnostic model by determining the interdependencies between the health and condition indicators 235 output by the complex system 200 and each assembly 205 of the complex system 200. As discussed above, when a health management system is coupled to a complex system 200, the health management system may receive any health indicators (such as DTCs) that have been generated and query the complex system 200 for condition indicators (such as PIDs). Accordingly, the processor 115 builds the dependency diagnostic model utilizing each health indicator and each condition indictor as entry point into the dependency diagnostic model. The processor 115, based upon the data extracted from the function models 140 and the health and condition indicator models 150 determines how each assembly 205 is linked to each health and condition indicator 235. As discussed above, each function model 140 and health and condition indicator model 150 includes an indication of every input and output corresponding to the model. The processor 115 traces through each model 140 and 150 to link each assembly 205 of the complex system 200 connected to the health or condition indicator 235 utilizing the program data dictionary 160 to account for any changes in the naming conventions used in any of the models 140 and 150. In other words, each health and condition indicator 235 in each health and condition indicator model 150 can be linked to the assemblies 205 responsible for generating the health and condition indicator 235 by tracing through the inputs and outputs of the assemblies 205 defined in the function models 140. For example, wheel speed sensors produce a signal reporting the speed that each wheel is spinning on a vehicle. An antilock brake system uses the reported values from the wheel speed sensors to determine if one or more wheels is locked (stopped from spinning) while braking is applied. If so, the antilock brake system automatically engages and disengages the brakes to keep the vehicle from skidding. Failure of one or more wheel speed sensors can render the antilock brake system unstable, disabling it from use, allowing the vehicle to skid. Accordingly, a condition indicator indicating an issue with, for example, an antilock brake system would be connected to the wheel speed sensor in dependency diagnostic model so that the issue with the antilock brake system could be easily diagnosed.

The result of the initially built dependency diagnostic model in Step 340 is a database which lists all monitored systems, and all possible propagation paths of failures in the complex system which result a health indicator being output by the complex system. In one embodiment, for example, the processor 115 may generate a database or tree type data structure for the generated model for each health and condition indicator 235 as the processor 115 traces through the function models 140 and the health and condition indicator models 150. However, the processor 115 may generate a data structure for the generated model in any manner which includes all monitored systems, their failure modes and all possible propagation paths of failures in the complex system.

The processor 115 may then optimize the generated model based upon the standard failure mode models 170 and propagation rules 180. (Step 350). The processor 115 can optimize the generated model by using the standard failure mode models 170 and propagation rules 180 to filter out dependency links that do not reflect the actual propagation of failure symptoms in the complex system 200.

In one embodiment, for example, the processor 115 determines the failure modes 225 for each assembly based upon an assembly type for each assembly. When the complex system is a vehicle, for example, the assembly types may include sensors, motors, valves, pumps, controllers, displays, radios, or the like. In one embodiment, for example, the processor 115 may determine the assembly type for each assembly 205 of the complex system 200 based upon a name of the assembly associated with each function model 140. For example, in an automatic environment, assembly names starting with the letter Y are typically sensors and assembly names starting with the letter A are typically valves.

The standard failure mode models 170 for the failure modes 225, as discussed above, include data on how each assembly 205 fails with respect to its own failures as well as the respective assembly's respond to being connected to another assembly 205 having a failure. Using the same example above, a wheel speed sensor which is coupled to an antilock brake system could fail due to a variety of reasons. For example, the sensor itself could fail, or one or more components downstream from the sensor, such as power systems, could completely fail or be outputting values out of range which is causing the wheel speed sensor to output a value out of range or not at all. The optimization in Step 350 correlates condition indicators with the failure modes 225 using the standard failure mode models 170 to simplify the diagnosis process. For example, suppose a power system connected to the wheel speed sensor, which is connected to the antilock brake system, is outputting a value out of range. This may cause an antilock braking system to output a health indicator indicating an error. The processor 115 based upon the function models, health and condition indicator models and program data dictionary may have generated a dependency diagnostic model in Step 340 may list dozens of systems and sub systems of the complex system which may be connected to perform the functions of the antilock brake system which could ultimately result in the identical health indicator being output by the complex system. By correlating one or more condition indicators, which a diagnostic system can request the value for from the complex system, indicating a value (i.e., output voltage) related to the power system with the standard failure modes of the antilock brake system, the wheel speed sensor and the underlying power system, the diagnosis process is dramatically simplified as many of the possible systems or subsystems which could be causing the same health indicator can be eliminated as suspects for causing the fault based upon the condition indicators and the fail modes.

As discussed above, the propagation rules 180 codify how errors propagate through the complex system. The errors may be categorized though the propagation rules. The propagation rules may define a category for each failure mode and each health indicator and the establish links therebetween as well as links to possible users complaints which do not result in a specific health indicator being output. If the category for a specific health indicator being output by a complex system cannot be matched with the same category for a failure mode of a specific system or subsystem, the specific system or subsystem can be eliminated as a possible cause of the health indicator.

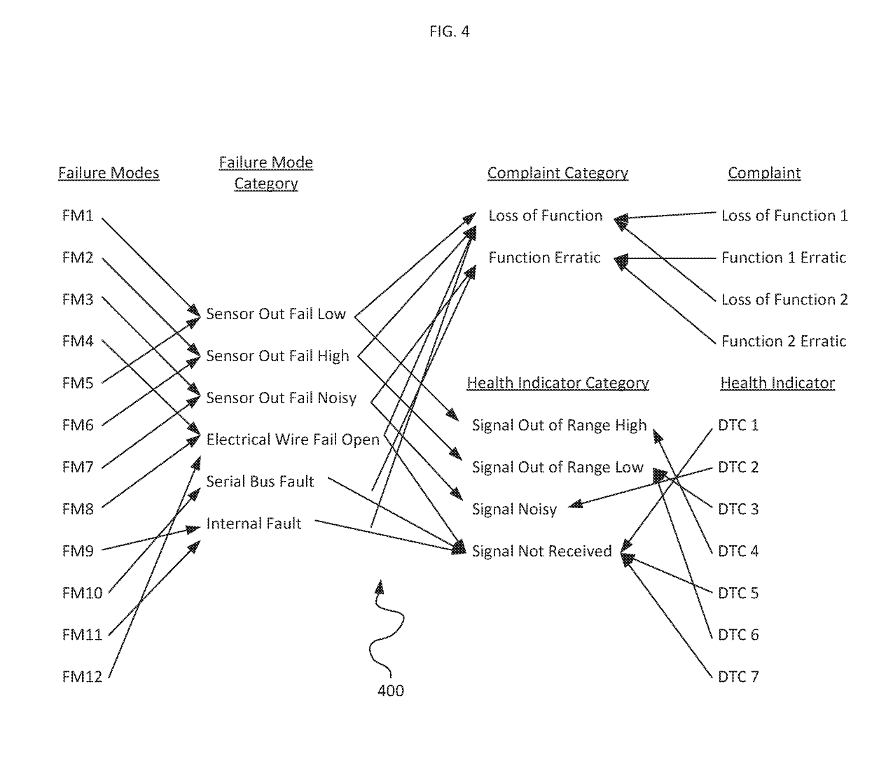

FIG. 4 is a flow diagram illustrating how the failure modes for a single subsystem of the complex system, customer complaints and health indicators are categorized and connected. As seen in FIG. 4, each of the twelve illustrated failure modes FM1 through FM12 is categorized into one of six possible failure mode categories. The exemplary failure mode categories are “Sensor Out Fail Low,” “Sensor Out Fail High,” “Sensor Out Fail Noisy,” “Electrical Wire Fail Open,” “Serial Bus Fault,” and “Internal Fault.” Likewise, each of the health indicators DTC1 through DTC 7 and each of the customer complaints are categorized into a complaint category or a health indicator category. As discussed above, the processor 115 can then then filter the optimized dependency diagnostic model by finding the subset of the possible linkages between the failure modes, health indicators and complaints and filtering this list to only include those relations where the category level items are already linked to each other, as indicated by the arrows 400.

As the propagation rules categorize the failure modes, customer complaints and health indicators, and the processor 115 establishes links therebetween as indicated by arrows 400, systems and subsystems of the complex system can easily be eliminated from causing a health indicator or a complaint. For example, as seen in FIG. 4, DTC 2 is categorized as a “Signal Noisy” Health indicator. Failure modes FM3 and FM7 are categorized in a “Sensor Out Fail Noisy” failure mode category, and, thus, are the only possible failure modes for the specific subsystem illustrated in FIG. 4 which could cause the health indicator DTC 7. As discussed above, the failure modes are correlated to condition indicators by the processor 115. Accordingly, a diagnostic system utilizing the optimized diagnostic model which is capable of requesting condition indicators from the complex system can quickly eliminate the system or subsystems as the cause of a health indicator. For example, if the condition indicator values for the subsystem illustrated in FIG. 4 are not present which could result in failure modes FM3 or FM7, the subsystem illustrated in FIG. 4 cannot be responsible for the health indicator DTC 7. As discussed above, a complex system may have dozens of systems or subsystems capable of causing the same health indicator.

Accordingly, by optimizing the dependency diagnostic fault model to correlate the condition indicators with the failure modes and categorizing the failure modes, complaints and health indicators, the resulting optimized diagnostic fault model can be utilized to quickly and accurately diagnose a complex system, dramatically reducing the cost of maintenance for the complex system.

The optimized dependency diagnostic model includes listings of all Failure Modes in the System, their Corrective Actions and listings of all Health Indicators, Functions and Operator Complaints associated with each Failure Mode.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system for building a dependency diagnostic model of a complex system having a plurality of assemblies, the system comprising:
a processor, the processor configured to:
receive at least one function model corresponding to each assembly of the complex system, at least one health and condition indicator model corresponding to an output of the complex system, a program data dictionary, standard failure mode models and propagation rules;
generate the dependency diagnostic model based upon interdependencies between the plurality of assemblies of the complex system and the output of the complex system based upon the at least one function model, the at least one health and condition indicator model and the program data dictionary; and
optimize the generated dependency diagnostic model based upon the standard failure mode models and the propagation rules.

2. The system of claim 1, wherein the processor is further configured to extract, from each function model, each input and each output for the assembly associated with the function model.

3. The system of claim 2, wherein the function model is a drawing of the assembly.

4. The system of claim 3, wherein the processor is further configured to:
convert the drawing into an XML file; and
extract each input and output for the assembly associated with the function model by parsing the XML file to determine each input and output.

5. The system of claim 4, wherein the processor is further configured to:
determine interdependencies between assemblies of the complex system and the output of the complex system by tracing through the input and output of each assembly to link each assembly.

6. The system of claim 1, wherein the output of the complex system includes a plurality of diagnostic trouble codes.

7. The system of claim 6, wherein the processor is further configured to determine the interdependencies between the plurality of assemblies of the complex system and the output of the complex system by linking one or more assemblies to each of the plurality of diagnostic trouble codes.

8. The system of claim 7, wherein the processor is further configured to optimize the generated dependency diagnostic model by filtering out at least one of the determined interdependencies of at least one of the assemblies linked to at least one of the plurality of diagnostic trouble codes based upon the propagation rules and the standard failure mode models.

9. The system of claim 1, wherein the output of the complex system includes a plurality of condition indicators each corresponding to a value output by one or more of the assemblies of the complex system.

10. The system of claim 9, wherein the processor is further configured to determine the interdependencies between the plurality of assemblies of the complex system and the output of the complex system by linking one or more assemblies to each of the plurality of condition indicators.

11. The system of claim 10, wherein the processor is further configured to optimize the generated dependency diagnostic model by filtering out at least one of the determined interdependencies of at least one of the assemblies linked to at least one of the plurality of condition indicators based upon the propagation rules and the standard failure mode models.

12. The system of claim 1, wherein the complex system is a vehicle.

13. A method for generating a dependency diagnostic model for a complex system having a plurality of assemblies, comprising:
receiving, by a processor, at least one function model corresponding to each assembly of the complex system, at least one health and condition indicator model corresponding to an output of the complex system, a program data dictionary, standard failure mode models and propagation rules;
generating, by the processor, the dependency diagnostic model based upon interdependencies between the plurality of assemblies of the complex system and the output of the complex system based upon the at least one function model, the at least one health and condition indicator model and the program data dictionary; and
optimizing, by the processor, the generated dependency diagnostic model based upon the standard failure mode models and the propagation rules.

14. The method of claim 13, further comprising determining the interdependencies by extracting, by the processor, each input and each output for each of the plurality of assemblies from the at least one function model associated with each respective assembly.

15. The method of claim 14, wherein the extracting further comprises:
converting, by the processor, each of the at least one function models to an XML file; and
extracting, by the processor, each input and output for the assembly associated with a respective function model by parsing the XML file to determine each input and output.

16. The method of claim 15, wherein the determining the interdependencies further comprises:
determining, by the processor, the interdependencies between assemblies of the complex system and the output of the complex system by tracing through the input and output of each assembly to link each assembly.

17. The method of claim 13, wherein the output of the complex system includes a plurality of diagnostic trouble codes, the determining the interdependencies further comprising:
determining, by the processor, the interdependencies between the plurality of assemblies of the complex system and the output of the complex system by linking one or more assemblies to each of the plurality of diagnostic trouble codes.

18. The method of claim 17, wherein the optimizing the generated dependency diagnostic model further comprises optimizing, by the processor, the generated dependency diagnostic model by filtering out at least one of the determined interdependencies of at least one of the assemblies linked to at least one of the plurality of diagnostic trouble codes based upon the propagation rules and the standard failure mode models.

19. The method of claim 13, wherein the output of the complex system includes a plurality of condition indicators each corresponding to a value output by one or more of the assemblies of the complex system, the determining the interdependencies further comprising:
determining, by the processor, the interdependencies between the plurality of assemblies of the complex system and the output of the complex system by linking one or more assemblies to each of the plurality of condition indicators.

20. The method of claim 19, wherein the optimizing the generated dependency diagnostic model further comprises optimizing, by the processor, the generated dependency diagnostic model by filtering out at least one of the determined interdependencies of at least one of the assemblies linked to at least one of the plurality of condition indicators based upon the propagation rules and the standard failure mode models.
